(19) United States
(12) Patent Application Publication
(10) Pub. No.: US 2009/0077162 A1
(43) Pub. Date: Mar. 19, 2009

(54) Medium Management Device and Medium Management Method

(76) Inventors: Monta Nakatsuka, Osaka (JP); Takayuki Fukui, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/886,718

(22) PCT Filed: Mar. 22, 2006
(86) PCT No.: PCT/JP2006/305686

§ 371 Date: Sep. 20, 2007

(30) Foreign Application Priority Data
Mar. 22, 2005 (JP) 2005-081031

(51) Int. Cl. G06F 15/16

(52) U.S. Cl. 709/203

(57) ABSTRACT

The medium management device includes a communicating unit (11) that communicates with the client device (20); a content data accumulating unit (13) that accumulates content data transmitted to and received from the client device (20); a remaining capacity obtaining unit (15) that obtains remaining capacity indicating an amount of free space secured by the content data accumulating unit (13); and a protocol processing unit (12) that returns, to the client device (20), the remaining capacity that is secured by the file data accumulating unit (13) and obtained by the remaining capacity obtaining unit (15), when the server device receives a request for obtaining auxiliary information (browse request) from the client device (20), the request being related to the content and including a keyword made up of a specific character string.

### TECHNICAL FIELD

The present invention relates to a medium management device and a medium management method that manages free space of a medium when a data file is transferred between devices.

### BACKGROUND ART

In recent years, the Internet connection has been rapidly spreading, with advances of broadband environment including xDSL and optical fibers, regardless of connections at companies and at home. Furthermore, home network environment that connects personal computers and electric appliances at home using the Ethernet (trademark), wireless LAN, and the like is becoming common. In such environments, not only personal computers (PC) but also home appliances, such as a television, a DVD recorder, an air-conditioner, and a refrigerator are being connected to each other via an Internet Protocol (IP) network standardized by the Internet Engineering Task Force (IETF).

As one of applications for the Internet and the home networks, there exists an application that copies, between the home appliances and PCs, an AV content file, such as an image or music (that transfers or moves a file). For example, a TV program recorded by an HDD recorder that is located at a living room is copied to a DVD medium using a DVD recorder located at another room.

Protocols for use in such transferring of a file include File Transfer Protocol (FTP) that has been used conventionally and Web-based Distributed Authoring and Versioning protocol (WebDAV) that is used recently. Furthermore, Universal Plug and Play Audio/Video (UPnP-AV) specification (Non Patent Reference 1) is notable recently as a protocol for handling, via a home network, an AV content file, such as images and music.

The UPnP-AV specification specifies services related to information attached to content files (metadata) and services related to connections, but does not specify transfer methods of the content file itself. Among the services, Contact Directory Service (CDS) that is a service regarding information attached to a content file (metadata) is the most basic service in the UPnP-AV specification, and it specifies actions, such as creating, deleting, and modifying of the content file (metadata) itself, besides obtaining of the content file (metadata). On the other hand, Hyper Text Transfer Protocol (HTTP) and Real-time Transport Protocol (RTP) are generally used as a transfer method of a content file for common use with the UPnP-AV specification.

Assuming that a device operated by a user is a client and a destination device connected to a network is a server, when a file is transferred from the server to the client using the UPnP-AV and the HTTP, first, a list of auxiliary information (metadata) of the content file is obtained from the server using CDS::Browse, and a URL enabling to transfer a content file desired to be transferred is obtained. This makes it possible to transfer the file using HTTP-GET. Conversely, when a file is transferred from the client to the server, the client requests the server to create, using CDS::CreateObject, auxiliary information (metadata) of the content file desired to be transferred from the client to the server (creation request), and the file is transferred to a destination of the URL included in a response to the creation request, using HTTP-POST.

Non Patent Reference 1: UPnP-AV specification

### DISCLOSURE OF INVENTION

### Problems that Invention is to Solve

Here, a problem is a method for checking an amount of free space in a disk which determines whether or not a file can be transferred.

Normally, when a file is transferred from a server to a client, since an amount of data of a content file to be transferred is described in auxiliary information (metadata) of the file, it is possible to determine whether or not the file can be transferred by comparing the amount of data to be transferred with free space of a disk at the client.

On the other hand, when a file is transferred from the client to the server, although an amount of data of a content file to be transferred is known, a mechanism for confirming an amount of free space in a disk at the server is not in place.

For example, when a file is transferred to a specific disk or a specific folder at the server, there are cases where information indicating an amount of free space is described in auxiliary information (metadata) of the specific disk or the specific folder. However, such information is not always described. The reason is that a disk, a folder, or the like that has been described using the CDS is merely conceptual and represented as a virtual Object.

Thus, the conceptual configuration of such disk or folder need not correspond to the actual physical configuration of the disk or folder. Thus, emergence of a technique for checking, in advance, an amount of free space of a disk at a server is strongly desired.

Thus, the object of the present invention is to solve the aforementioned problem and to provide a medium management device and a medium management method that can check, in advance, an amount of free space of a disk at a server.

### Means to Solve the Problems

In order to achieve the aforementioned object, the medium management device according to the present invention is a medium management device that is used as a server device, the server device being connected, via a network, to communicate with a client device operated by a user and transmitting and receiving file data to and from the client device, and the medium management device includes a communicating unit that communicates with the client device; a file data accumulating unit that accumulates the file data transmitted to and received from the client device; a remaining capacity obtaining unit that obtains remaining capacity indicating an amount of free space secured by the file data accumulating unit; and a protocol processing unit that returns, to the client device, the remaining capacity that is secured by the file data accumulating unit and obtained by the remaining capacity obtaining unit, when the protocol processing unit receives a request for obtaining auxiliary information from the client device, the request being related to the file data and including a keyword made up of a specific character string.

With this, it is possible that the client device checks, in advance, the amount of free space of a disk at the server device, before transferring file data.

Note that the present invention can be realized not only as such medium management device but also as a medium management method having the characteristic units of the aforementioned medium management device as steps, and as a program which causes a computer to execute such steps. Furthermore, it is obvious that such program can be distributed via a recording medium, such as a CD-ROM and via a transmission medium, such as the Internet.

### EFFECTS OF THE INVENTION

As clarified in the aforementioned description, according to the medium management device of the present invention, it is possible that the client device checks, in advance, the amount of free space of a disk at the server device, before transferring file data.

Thus, with the present invention, applications that copy AV content files, such as video and music, via the Internet and home networks between home appliances and personal computers will come to market, and the present invention is highly practical today when the UPnP-AV specifications are becoming widely available.

### BRIEF DESCRIPTION OF DRAWINGS

FIG. 1 is a block diagram showing the configuration of the entire system according to the first embodiment.

FIG. 2 is a block diagram showing the configuration for the main functions of the server device 10 shown in FIG. 1.

FIG. 3 is a diagram showing the configuration for managing the content data in the server device 10.

FIG. 4 is a block diagram showing the configuration for the main functions of the client device 20 shown in FIG. 1.

FIG. 5 is a diagram showing an example of Simple Object Access Protocol (SOAP) for sending the CDS::Browse action with the aforementioned parameter.

FIG. 6 is a diagram showing a sequence for checking an amount of free space between a server device and a client device.

FIG. 7 is a diagram showing an example of container information included in a response command.

FIG. 8 is a diagram showing another sequence for checking an amount of free space between the server device 20 and the client device 10.

FIG. 9 is a diagram showing an example of description of the ProtocolInfo information.

### NUMERICAL REFERENCES

3 Communication path
10 Server device
11,21 Communicating unit
12,22 UPnP-AV protocol processing unit
13,24 Content data accumulating unit
14 Content data receiving unit
15 Remaining capacity obtaining unit
20 Client device
23 Content data sending unit
25 Capacity comparing unit
31 ROOT container
32 Video container
33 Audio container
34 Photo container

### BEST MODE FOR CARRYING OUT THE INVENTION

The embodiments according to the present invention are described with reference to the diagrams hereinafter.

### FIRST EMBODIMENT

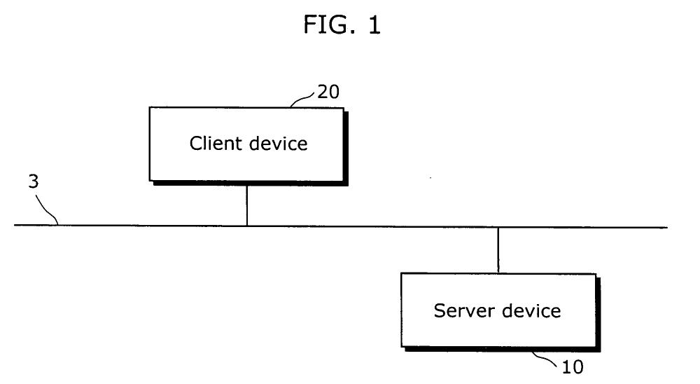

FIG. 1 is a block diagram showing the configuration of an entire system according to the first embodiment.

As shown in FIG. 1, the system includes a server device 10, a client device 20, and a communication path 3 that enables connection between the server device 10 and the client device 20.

The communication path 3 includes a wired communication path, such as Ethernet (trademark), and a wireless communication path, such as IEEE802.11b/g and Bluetooth.

The server device 10: sends file data requested by the client device 20, for example, a content, such as video, music, and a still image; returns, to the client device 20, remaining capacity indicating an amount of free space secured by the server device 10; and accumulates the content sent from the client device 20.

The client device 20 recognizes the server device 10 with a device search function of the UPnP. When obtaining a content, the client device 20 obtains a list of auxiliary information of the content file (metadata) using CDS::Browse from the server device 10. By obtaining a URL enabling to transfer the content file, the file is transferred using HTTP-GET. Conversely, when a content is transferred, an auxiliary information obtaining request regarding the file data including a keyword made up of a specific character string is sent to the server device 10. Then, the client device 20 receives, from the server device 10, the remaining capacity secured by the server device 10 so as to check the remaining capacity in advance. The client device 20 transfers the content to the server device 10, when the content to be transferred is larger than the remaining capacity.

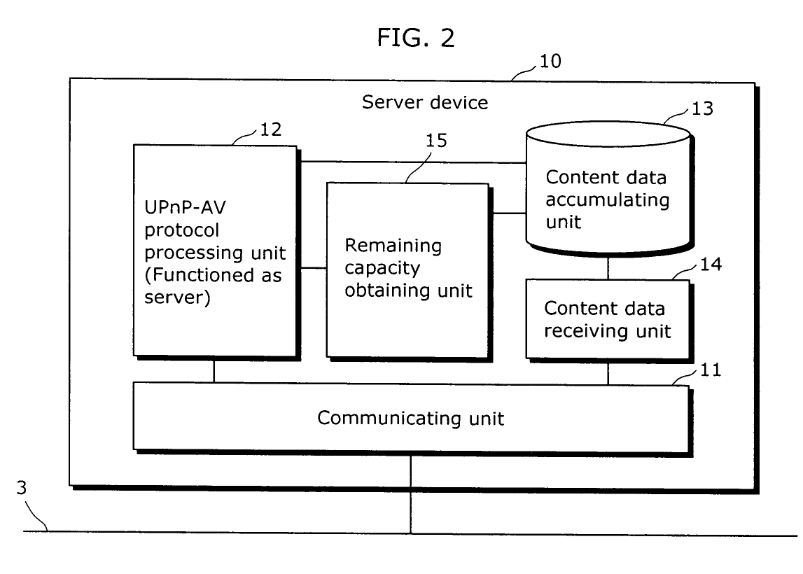

Next, the detailed configuration of the server device 10 and the client device 20 is described in order. FIG. 2 is a block diagram showing the configuration for the main functions of the server device 10 shown in FIG. 1.

As shown in FIG. 2, the server device 10 includes a communicating unit 11, a UPnP-AV protocol processing unit 12 in conformity with the UPnP-AV specification (also referred to as “UPnP-AV protocol processing unit” hereinafter), a content data accumulating unit 13, a content data receiving unit 14, and a remaining capacity obtaining unit 15.

The communicating unit 11 communicates with the client device 20 via the communication path 3. The UPnP-AV protocol processing unit 12 executes processing, such as ability exchange and a device search which are in conformity with the UPnP-AV specification. Furthermore, the UPnP-AV protocol processing unit 12 receives a UPnP-AV command sent from the client device in conformity with the UPnP-AV specification, and operates in accordance with the received command.

The content data accumulating unit 13 accumulates a recorded television program, moving image data captured by a digital video camera (DVC), still image data captured by a digital still camera (DSC), and voice data such as a recorded radio program and music tunes of compact disc (CD) (hereinafter, referring each moving image data, still image data, and voice data as content data).

The client device 20 obtains, via the UPnP-AV protocol processing unit 12, title information of such content data, size information, voice/image recording date information, location information of the content data represented by Uniformed Resource Locator (URL), and the like (these information are referred to as metadata hereinafter), in response to a UPnP-AV command request.

The remaining capacity obtaining unit 15 obtains an amount of free space (remaining capacity) of content data capable of being accumulated in the content data accumulating unit 13.

The UPnP-AV protocol processing unit 12 obtains, via the remaining capacity obtaining unit 15, an amount of free space in the content data accumulating unit 13, and returns the amount in response to the UPnP-AV command requesting the free space from the client device.

The content data receiving unit 14 accumulates, in the content data accumulating unit 13, the content data sent from the client device, using Hyper Text Transport Protocol (HTTP) and the like.

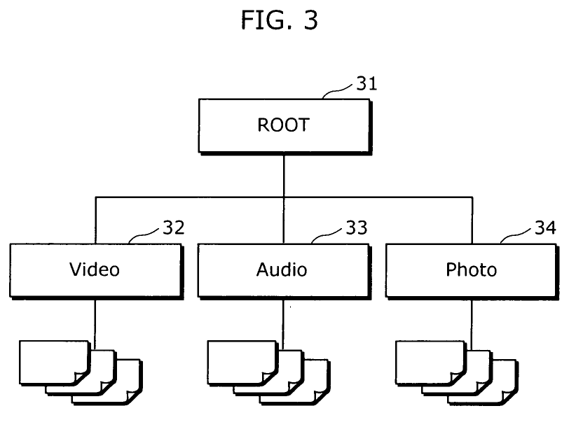

FIG. 3 is a diagram showing the configuration for managing content data in the server device 10. This configuration includes content data and containers which are virtual folders for managing data. Although each container stores content data and a container, there are cases where the containers do not include the stored content data and the containers. Furthermore, since the configuration for managing the content data is based on a logical management concept recognized by the client device via the UPnP-AV protocol processing unit 12, the aforementioned configuration needs not be physically reproduced on an actual file system of the content data accumulating unit 13.

In FIG. 3, each container stores data, such as video, music, and a still image. In other words, the configuration starts from a ROOT container 31 located on a highest order of the configuration, and includes a video container 32 for storing video, an audio container 33 for storing music, and a photo container 34 for storing a still image.

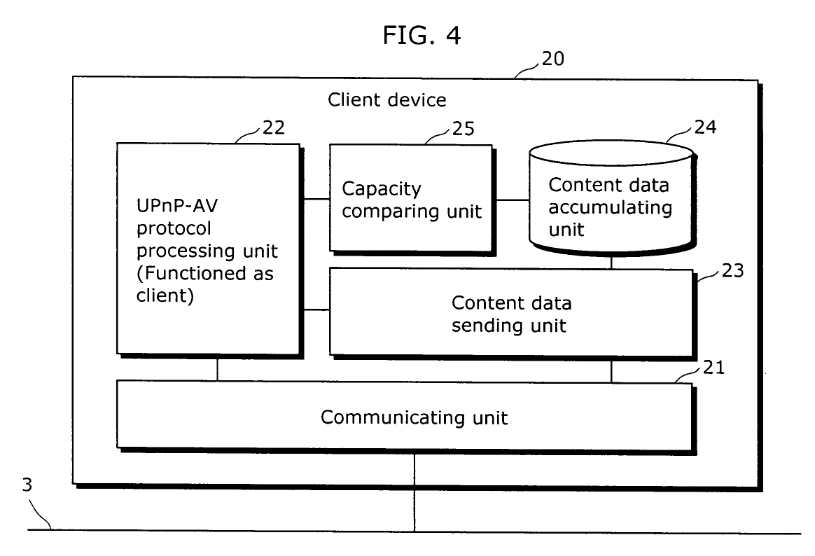

FIG. 4 is a block diagram showing the configuration for the main functions of the client device 20 shown in FIG. 1.

As shown in FIG. 4, the client device 20 includes a communicating unit 21, a UPnP-AV protocol processing unit 22 in conformity with the UPnP-AV specification (referred to as “UPnP-AV protocol processing unit” hereinafter), a content data sending unit 23, a content data accumulating unit 24, and a capacity comparing unit 25.

The communicating unit 21 communicates with the server device 10 via the communication path 3. The UPnP-AV protocol processing unit 22 sends a UPnP-AV command to the server device that conforms to the UPnP-AV specification, and remotely controls the server device.

The content data accumulating unit 24 accumulates content data. The capacity comparing unit 25 compares the capacity of the content data capable of being received at the server device with the capacity of the sent content data, and judges whether the server device can receives the data or not.

The content data sending unit 23 sends, to the server device, the content data accumulated in the content data accumulating unit 24.

Here, the client device 20 recognizes the server device 10 with a device search function of the UPnP. Then, the client device 20 executes a CDS::Browse action for checking whether the server device completely receives the content data that is desired to be sent and whether the server device 10 has enough space for storing the content data in the content data accumulating unit 13 of the server device 10 or not, before sending the content data to the server device 10. This CDS::Browse is a UPnP-AV command for obtaining information stored in the content data accumulating unit 13.

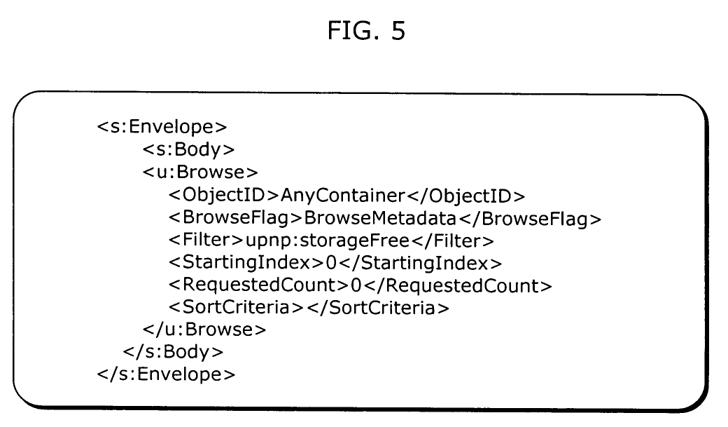

FIG. 5 is a diagram showing an example of Simple Object Access Protocol (SOAP) for sending the CDS::Browse action with the aforementioned parameter.

Here, a container is specified using a keyword “AnyContainer”. It is assumed that “AnyContainer” is a reserved keyword indicating that the server device may select a container convenient for the server device, without identifying a storage destination for the content data by the client device.

As a next target for obtaining information, a flag is set, which selects either obtainment of information of the specified container itself or obtainment of information of all containers and the content data included in the specified container. Here, since the information of the container itself is necessary to be obtained, “BrowseMetadata” is set as the flag.

Furthermore, although the client device specifies necessary attribute information, “upnp:storageFree” is specified as a keyword since the client device needs to check the free space. Furthermore, “0” is specified for indicating a starting point for obtaining data and the number of obtained data. However, a sorting keyword is not specified here.

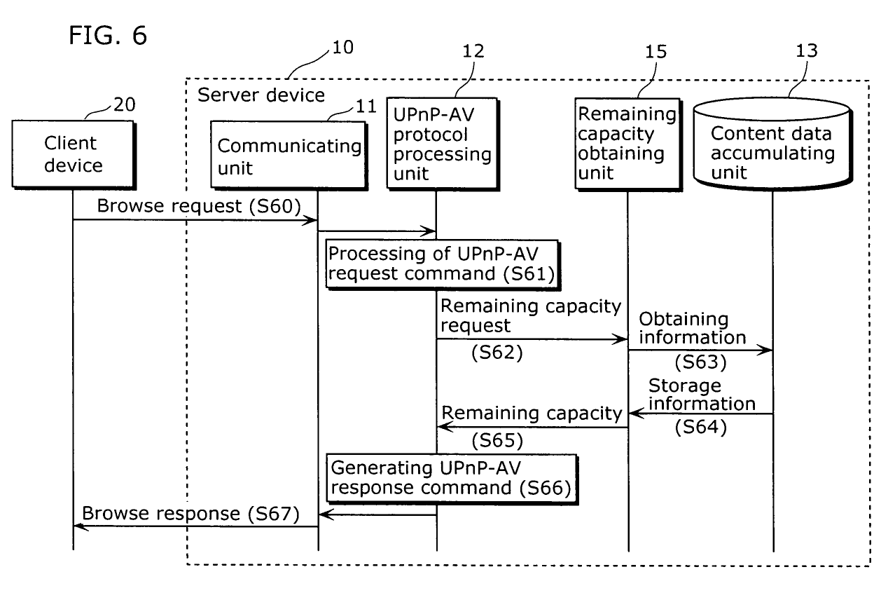

FIG. 6 is a diagram showing a sequence for checking an amount of free space between the server device and the client device.

The client device 20 sends a CDS::Browse request command including the description shown in FIG. 5 (S60).

The UPnP-AV protocol processing unit 12 of the server device 10 that has received the CDS::Browse request command processes the CDS::Browse request command (S61), and obtains an amount of free space of a container specified by the client device 20 based on the details of the command (S62, S63, S64, S65).

Here, since the client device 20 specifies “AnyContainer” as a target container, the UPnP-AV protocol processing unit 12 of the server device 10 selects an arbitrary container. Here, since “Video” is selected as an example, the UPnP-AV protocol processing unit 12 generates a CDS::Browse response command including an identifier that identifies a container “Video” (for example, container id=2) and the amount of free space (S66), and returns the response command to the client device 20 (S67).

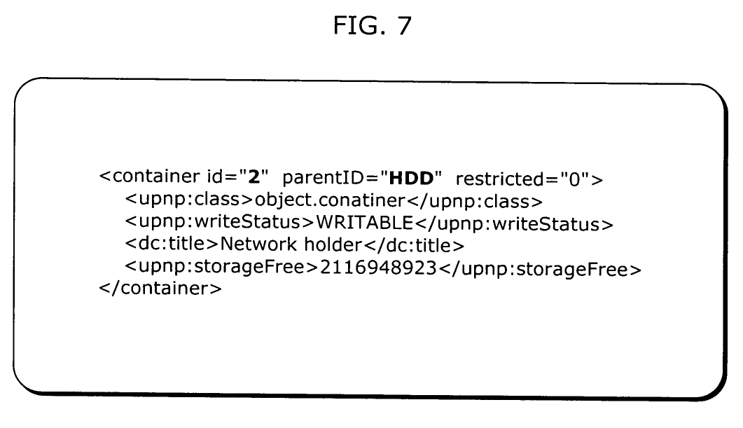

FIG. 7 is a diagram showing an example of container information included in a response command. The UPnP-AV protocol processing unit 22 of the client device 20 can recognize, in advance, that “Video” is actually allocated as “AnyContainer” and the remaining capacity is 2116948923 by analyzing the response data received from the server device 10 via the communicating unit 21.

The capacity comparing unit 25 compares a size of content data that is desired to be sent and the remaining capacity in the content data accumulating unit 13 of the server device 10 so as to determine whether or not the content data is to be sent.

Here, in the UPnP-AV protocol specification, a container and content data are classified into various classes according to the type, and the attribute held by each class is different. The description “upnp:storageFree” is an attribute held by each class, such as “object.container.storagevolume” and “object.container.storageVolume”. However, when the server device receives a CDS::Browse action that corresponds to “AnyContainer”, it must provide an attribute “upnp:storageFree” and set a value for all of the container classes.

When the capacity comparing unit 25 checks that the content data accumulating unit 13 of the server device 10 has enough space, the content data sending unit 23 of the client device 20 sends the content data. Then, the content data receiving unit 14 of the server device 10 receives the content data sent from the client device 20 via the communicating unit 11, and stores the data in the content data accumulating unit 13.

Thus, in the server side at which a file is received, by specifying a folder indicating an amount of free space as a storage destination of a particular Object, the client can check an amount of space for the particular Object before transferring the file.

Note that although a character “AnyContainer” is used as a reserved keyword in the aforementioned embodiment, the character is not limited to this. Furthermore, the similar advantage can be obtained by checking a reserved keyword that enables execution of only remaining capacity, such as “FreeSpace”.

Furthermore, when in file configuration information to be distributed to the client device 20, an item indicating only the remaining capacity secured by the file data accumulating unit 13 is specified and the keyword corresponds to the item, it is possible that the protocol processing unit returns, to the client device 20, the item indicating only the remaining capacity.

### SECOND EMBODIMENT

Next, a system of the second embodiment according to the present invention is described. Note that the configuration of the client device 20 and the server device 10 of the second embodiment is the same as that of the first embodiment, and the processing in the server device 10 and information transmitted and received between the client device 20 and the server device 10 is different. Thus, the following describes only different points from the configuration described in the first embodiment.

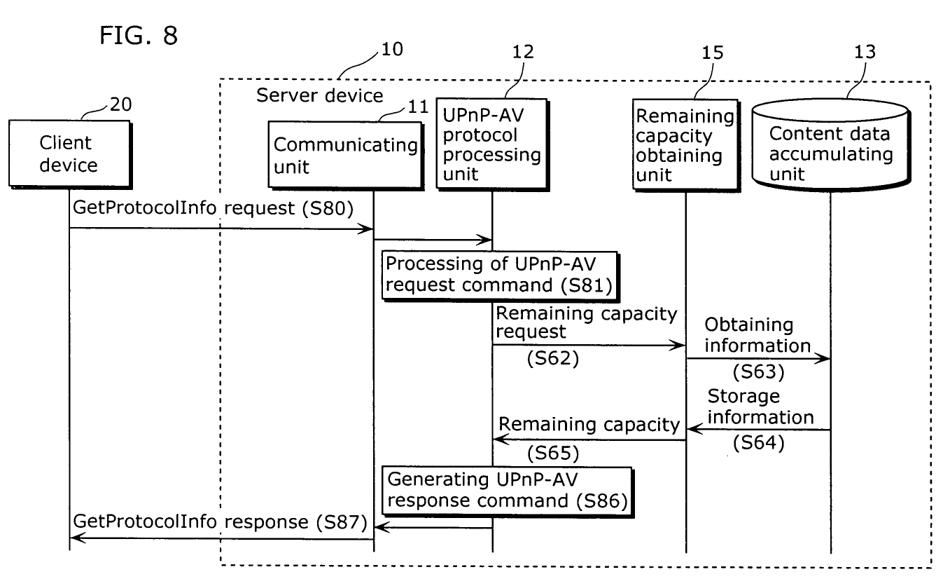

FIG. 8 is a diagram showing another sequence for checking an amount of free space between the server device 10 and the client device 20.

The client device 20 sends a CMS::GetProtocolInfo request command shown in FIG. 8 (S80), instead of the CDS::Browse request command. Here, Connection Management Service (CMS) is one of the UPnP-AV specifications, and a service for managing connection.

The UPnP-AV protocol processing unit 12 of the server device 10 that has received the CMS::GetProtocolInfo request command processes the CMS::GetProtocolInfo request command (S81), and obtains, via the remaining capacity obtaining unit 15, an amount of free space of a container specified by the client device 20 based on the details of the command (S62, S63, S64, S65).

With the CMS::GetProtocolInfo request command, a format of a content supported by the server device and the ProtocolInfo information described based on the protocol are returned to the client device 20. Specifically, the UPnP-AV protocol processing unit 12 of the server device 10 can transfer a file from the client device 20 based on the format of the content and the protocol, and describes remaining capacity in the fourth parameter of the ProtocolInfo information based on the description information that describes amounts of remaining capacity secured by each of media managed by the content data accumulating unit 13. After obtaining information of the remaining capacity, the UPnP-AV protocol processing unit 12 generates a CMS::GetProtocolInfo response command (S86), and returns the command to the client device 20 (S87).

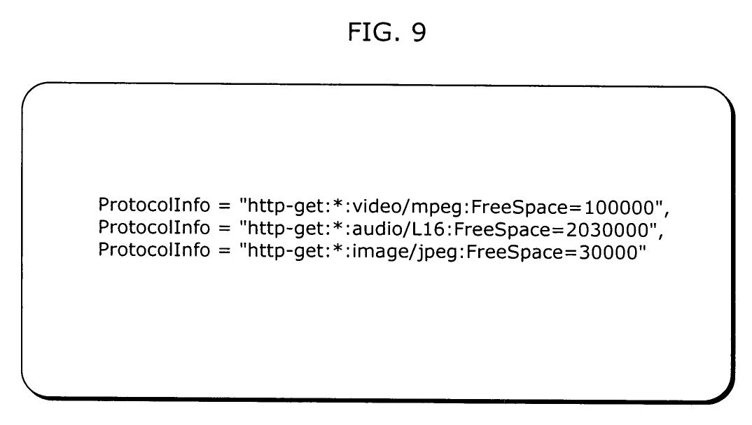

FIG. 9 is a diagram showing an example of description of ProtocolInfo information. In the fourth parameter separated by “:”, “FreeSpace=” is specified, and a value is described after “FreeSpace=” on a capacity unit basis (byte or MegaByte). In the example of the diagram, it is possible to describe respective amounts of free space for each of video information, music information and still image information.

Thus, in the server side at which a file is received, by specifying a medium or a folder indicating only an amount of free space as a storage destination of a particular Object, the client can check free space for the particular Object before transferring the file.

Note that although file data is described as a content, such as video, music, and a still image in the second embodiment, it is obvious that the file data can be described as text data.

### INDUSTRIAL APPLICABILITY

The medium management device according to the present invention can be applied to a computer device that can be used as a network, and conforms to the UPnP-AV specification, such as a HDD video recorder, a set top box, and a personal computer.

1-6. (canceled)

7. A medium management device that is used as a server device, the server device being connected, via a network, to communicate with a client device operated by a user and transmitting and receiving file data to and from the client device, said medium management device comprising:
a communicating unit operable to communicate with the client device;
a file data accumulating unit operable to accumulate the file data transmitted to and received from the client device in each of folders;
a remaining capacity obtaining unit operable to obtain remaining capacity for each of the folders, the remaining capacity indicating an amount of free space secured by said file data accumulating unit; and
a protocol processing unit operable to select one of the folders that are secured by said file data accumulating unit and are obtained by said remaining capacity obtaining unit, and to distribute, to the client device, file configuration information of a file, the file configuration information including remaining capacity of the selected folder, when said protocol processing unit receives a request for obtaining information from the client device, the request being related to the remaining capacity and including a keyword that is made up of a specific character string and that identifies none of the folders.

8. The medium management device according to claim 7,
wherein said protocol processing unit is operable to select, from among the folders, one of the folder to be allocated only for indicating the amount of free space.

9. The medium management device according to claim 7,
wherein a folder or an item is specified in file configuration information to be distributed to the client device, the folder or the item indicating only the remaining capacity secured by said file data accumulating unit, and
said protocol processing unit is operable to distribute, to the client device, the folder or the item indicating only the remaining capacity, when the keyword corresponds to the folder or the item.

10. The medium management device according to claim 7,
wherein said file data accumulating unit is operable to manage description information describing respective amounts of free space secured for each of media, and
said protocol processing unit is operable to distribute, to the client device, remaining capacity for each of the media, when the keyword corresponds to the description information.

11. The medium management device according to claim 7, further comprising
a file data receiving unit operable to receive the file data from the client device via said communicating unit, and to store the received file data in a specific location secured by said file data accumulating unit.

12. A medium management method which is used for a server device, the server device being connected, via a network, to communicate with a client device operated by a user and transmitting and receiving file data to and from the client device, said medium management method comprising:
a communicating step of communicating with the client device;
a file data accumulating step of accumulating the file data transmitted to and received from the client device in each of folders;
a remaining capacity obtaining step of obtaining remaining capacity for each of the folders, the remaining capacity indicating an amount of free space secured in said file data accumulating step; and
a protocol processing step of selecting one of the folders that are secured in said file data accumulating step and are obtained in said remaining capacity obtaining step, and distributing, to the client device, file configuration information of a file, the file configuration information including remaining capacity of the selected folder, when a request for obtaining auxiliary information is received from the client device, the request being related to the remaining capacity and including a keyword that is made up of a specific character string and that identifies none of the folders.

13. A program for causing a computer to execute the steps included in the medium management method according to claim 12.
